(19) United States
(12) Patent Application Publication
(10) Pub. No.: US 2026/0016580 A1
(43) Pub. Date: Jan. 15, 2026

(54) ADAPTIVE LIDAR SCANNING BASED ON RGB INFORMATION

(71) Applicant: University of Florida Research Foundation, Incorporated, Gainesville, FL (US)

(72) Inventors: Jing Du, Gainesville, FL (US); Yang Ye, Gainesville, FL (US); Fang Xu, Gainesville, FL (US); Pengxiang Xia, Gainesville, FL (US); Hengxu You, Gainesville, FL (US)

(21) Appl. No.: 19/258,429

(22) Filed: Jul. 2, 2025

Related U.S. Application Data
(60) Provisional application No. 63/670,334, filed on Jul. 12, 2024.

(51) Int. Cl. G01S 7/497; G01S 17/86; G01S 17/89; G06T 7/50; G06T 7/90

(52) U.S. Cl. CPC G01S 7/497; G01S 17/86; G01S 17/89; G06T 7/50; G06T 7/90; G06T 2207/10024; G06T 2207/20084

(57) ABSTRACT

A method comprising generating, using a convolutional neural network model, one or more candidate objects based on one or more images of a scene, wherein the one or more images comprise one or more color depth images that are captured by a camera sensor; determining one or more uncertainty scores for the one or more candidate objects based on an information entropy function; and initiating, using a sparse light detection and ranging (LiDAR) sensor, scanning of one or more regions of interest (ROIs) that are determined based on the one or more uncertainty scores, wherein the scanning comprises (i) initiating capture of one or more enhancement frames for the one or more ROIs and (ii) generating one or more detected objects from the one or more ROIs based on the one or more enhancement frames.

### CROSS REFERENCE TO RELATED APPLICATION

This application claims the priority of U.S. Provisional Application No. 63/670,334, entitled “ADAPTIVE LIDAR SCANNING BASED ON RGB INFORMATION,” filed on Jul. 12, 2024, the disclosure of which is hereby incorporated by reference in its entirety.

### GOVERNMENT SUPPORT

This invention was made with government support under Grant 70NANB21H025, awarded by the NATIONAL INSTITUTE OF STANDARDS AND TECHNOLOGY (NIST). The government has certain rights in the invention.

### TECHNICAL FIELD

Various embodiments of the present disclosure relate to computer vision, and more particularly to enhancing image scans for object detection.

### BACKGROUND

Accurate understanding of scenes through vision may play a critical role in construction automation technologies, particularly in navigating the challenges of occlusions and object stacking. However, methods may be desired to adaptively gather essential data for precise detection, bypassing unnecessary data storage and computational expenses, to strike a balance between capture robustness and efficiency.

### BRIEF SUMMARY

Various embodiments described herein relate to methods, apparatus, systems, computing devices, computing entities, and/or the like for enhancing the scan resolution of low-end, sparse light detection and ranging (LiDAR) scanners.

According to some embodiments, a computer-implemented method comprises generating, by one or more processors and using a convolutional neural network model, one or more candidate objects based on one or more images of a scene, wherein the one or more images comprise one or more color depth images that are captured by a camera sensor; determining, by the one or more processors, one or more uncertainty scores for the one or more candidate objects based on an information entropy function; and initiating, by the one or more processors and using a sparse light detection and ranging (LiDAR) sensor, scanning of one or more regions of interest (ROIs) that are determined based on the one or more uncertainty scores, wherein the scanning comprises (i) initiating capture of one or more enhancement frames for the one or more ROIs and (ii) generating one or more detected objects from the one or more ROIs based on the one or more enhancement frames.

In some embodiments, initiating the scanning further comprises scanning the one or more ROIs with one or more resolutions based on the one or more uncertainty scores. In some embodiments, the LiDAR sensor is calibrated by generating a transformation matrix that transforms data from the one or more color depth images corresponding to the one or more ROIs into one or more LiDAR points in a three-dimensional coordinate system. In some embodiments, the one or more enhancement frames comprises one or more scanning frames corresponding to the one or more ROIs from a plurality of viewpoints. In some embodiments, generating the one or more detected objects further comprises combining the one or more enhancement frames by merging the one or more scanning frames from the plurality of viewpoints. In some embodiments, generating the one or more detected objects further comprises generating, using a classifier model, one or more predictions based on surface point cloud data, wherein the one or more predictions comprises a confidence score vector that corresponds to the one or more detected objects. In some embodiments, a reliability of the one or more detected objects is determined based on one or more information entropies of the one or more ROIs satisfying an information entropy threshold. In some embodiments, generating the one or more candidate objects further comprises determining, using red, green, blue (RGB) computer vision-based object detection, one or more confidence scores for the one or more candidate objects.

According to some embodiments, a system comprises one or more processors and at least one memory storing processor-executable instructions that, when executed by any of the one or more processors, causes the one or more processors to perform operations comprising generating, using a convolutional neural network model, one or more candidate objects based on one or more images of a scene, wherein the one or more images comprise one or more color depth images that are captured by a camera sensor; determining one or more uncertainty scores for the one or more candidate objects based on an information entropy function; and initiating, using a sparse light detection and ranging (LiDAR) sensor, scanning of one or more regions of interest (ROIs) that are determined based on the one or more uncertainty scores, wherein the scanning comprises (i) initiating capture of one or more enhancement frames for the one or more ROIs and (ii) generating one or more detected objects from the one or more ROIs based on the one or more enhancement frames.

In some embodiments, initiating the scanning further comprises scanning the one or more ROIs with one or more resolutions based on the one or more uncertainty scores. In some embodiments, the operations further comprise calibrating the LiDAR sensor by generating a transformation matrix that transforms data from the one or more color depth images corresponding to the one or more ROIs into one or more LiDAR points in a three-dimensional coordinate system. In some embodiments, the one or more enhancement frames comprises one or more scanning frames corresponding to the one or more ROIs from a plurality of viewpoints. In some embodiments, generating the one or more detected objects further comprises combining the one or more enhancement frames by merging the one or more scanning frames from the plurality of viewpoints. In some embodiments, generating the one or more detected objects further comprises generating, using a classifier model, one or more predictions based on surface point cloud data, wherein the one or more predictions comprises a confidence score vector that corresponds to the one or more detected objects. In some embodiments, the operations further comprise determining a reliability of the one or more detected objects based on one or more information entropies of the one or more ROIs satisfying an information entropy threshold. In some embodiments, generating the one or more candidate objects further comprises determining, using red, green, blue (RGB) computer vision-based object detection, one or more confidence scores for the one or more candidate objects.

According to some embodiments, one or more non-transitory computer-readable storage media including instructions that, when executed by one or more processors, cause the one or more processors to perform operations comprising generating, using a convolutional neural network model, one or more candidate objects based on one or more images of a scene, wherein the one or more images comprise one or more color depth images that are captured by a camera sensor; determining one or more uncertainty scores for the one or more candidate objects based on an information entropy function; and initiating, using a sparse light detection and ranging (LiDAR) sensor, scanning of one or more regions of interest (ROIs) that are determined based on the one or more uncertainty scores, wherein the scanning comprises (i) initiating capture of one or more enhancement frames for the one or more ROIs and (ii) generating one or more detected objects from the one or more ROIs based on the one or more enhancement frames.

In some embodiments, initiating the scanning further comprises scanning the one or more ROIs with one or more resolutions based on the one or more uncertainty scores. In some embodiments, the operations further comprise calibrating the LiDAR sensor by generating a transformation matrix that transforms data from the one or more color depth images corresponding to the one or more ROIs into one or more LiDAR points in a three-dimensional coordinate system. In some embodiments, the one or more enhancement frames comprises one or more scanning frames corresponding to the one or more ROIs from a plurality of viewpoints.

### BRIEF DESCRIPTION OF THE DRAWINGS

Embodiments incorporating teachings of the present disclosure are shown and described with respect to the figures presented herein.

FIG. 1 is a diagram of an example architecture in accordance with some embodiments of the present disclosure.

FIG. 2 provides an example computing entity in accordance with some embodiments of the present disclosure.

FIG. 3 is a diagram of an example adaptive scanning system in accordance with some embodiments of the present disclosure.

FIG. 4 presents a flowchart of an example process for enhancing image scans in accordance with some embodiments of the present disclosure.

FIG. 5 is a diagram of an example single-shot multi-box detection (SSD) model in accordance with some embodiments of the present disclosure.

FIG. 6 presents a flowchart of an example process for initiating LiDAR scanning based on one or more regions of interest (ROIs) in accordance with some embodiments of the present disclosure.

FIG. 7 are renderings of example clustering results for desk groups in accordance with some embodiments of the present disclosure.

FIG. 8 is a rendering of an example clustering result for a pipe group in accordance with some embodiments of the present disclosure.

FIG. 9A and FIG. 9B are first view renderings of example augmented results of adaptive scanning on ROIs in accordance with some embodiments of the present disclosure.

FIG. 10A and FIG. 10B are second view renderings of example detailed detection results of ROIs in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides systems and methods for enhancing object segmentation and detection of complex geometries through an adaptive, hybrid scanning system that integrates red, green, and blue (RGB) computer vision data analysis. By identifying regions of uncertainty using computer vision techniques, light detection and ranging (LiDAR) scans may be selectively augmented as appropriate, for example, based on Shannon information entropy metrics, thereby significantly improving detection accuracy and efficiency, and enabling high- resolution results with economically sparse LiDAR systems. Embodiments of the present disclosure may minimize computational overhead and unnecessary data capture, which may be beneficial for applications that demand precise spatial analysis with constrained resources.

In some embodiments, a two-tiered approach is applied, using RGB data to pinpoint uncertain areas, followed by LiDAR scans for detailed data acquisition. As such, at least some of the disclosed embodiments may improve detection accuracy and efficiency by focusing on critical regions, reducing computational demands and scan time.

Vision-based scene understanding (e.g., the ability to perceive and comprehend the geometric and semantic aspects of an environment through visual data) may be critical for automation technologies, particularly in the field of construction. In addition to following human commands, an intelligent system, such as a robot, may be configured to make spontaneous decisions regarding the safest and most efficient strategies to accomplish tasks in complex and dynamic construction workplaces. For example, object-oriented locating, searching, and manipulation tasks, may comprise configuring intelligent systems to construct high-accuracy scene understanding models for downstream action planning. Reality capture techniques, such as LiDAR, depth cameras, and computer vision methods (e.g., based on visual sensor information) may be used to collect environmental data in real-time. LiDAR sensors may be advantageous in capturing high-resolution spatial information with a large reachable range and may be less affected by lighting changes or disturbances. RGB cameras may be used in conjunction with depth cameras to capture detailed texture information, such as color and boundaries along with geometric ranging information, which may be used to solve various vision tasks. A variety of machine learning algorithms may also be employed for segmentation, detection, and object recognition to further aid in action planning.

Achieving a balance between robustness and efficiency of a reality capture workflow may be challenging for construction workplaces. For example, it may be challenging to enable effective and accurate object segmentation and detection of construction workplaces. Such challenges may stem from the complexity and dynamics of modern construction workplaces (e.g., “geometrical nontriviality”) that hinder accurate detection, identification, and reconstruction of three-dimensional (3D) geometries of individual objects from two-dimensional (2D) images or scans captured from a limited number of viewpoints. Examples of such nontrivial geometrical scenarios may include occlusions, object stacking, and insignificant silhouette features from certain observation angles. Construction workplaces may be quite complex given large structures and job sites, and a plurality of static and dynamic objects, such as equipment, materials, and workers interacting unexpectedly. Additionally, certain activities that occur at construction workplaces may utilize oversized equipment to maneuver through confined spaces with minimal clearance. As such, construction workplaces and activities that occur at the construction workplaces may be fast-changing and sometimes out of sequence, presenting complex and dynamic features that are challenging for reality capture and scene understanding.

Acquiring additional scans from different viewpoints or increasing the resolution of each scan by using high-end scanners may provide additional information for helping resolve ambiguities and improving the accuracy of object segmentation and detection. However, acquiring multiple scans or increasing scan resolutions may be expensive and time-consuming, particularly for large or complex scenes. Additionally, geometric constraints involved in scanning a scene from multiple viewpoints may prevent the capture of necessary data. Even with multiple scans, significant ambiguities may still exist in the reconstruction process because an increased number of viewpoints may fail to capture important feature aspects of a scene and may instead provide redundant information. In certain cases, while increasing the resolution of reality capture data may be helpful for object detection in regions of interest (ROIs), noise data may be introduced that may hinder identification of object boundaries. For example, if two objects are in proximity, a higher resolution may result in a greater number of data points along edges and in small gaps between the edges, which may obscure boundary detection of the two objects. Boundary detection may be especially challenging when attempting to accurately identify boundaries in complex scenes with cluttered backgrounds. Thus, there is a desire for computationally efficient yet robust scanning techniques to minimize necessary scanning data for high quality scene understanding.

According to various embodiments, adaptive reality capture systems and methods are provided for robust object segmentation and detection (e.g., in particular, of construction workplaces with nontrivial geometrical features). The disclosed adaptive reality capture systems and methods may enhance the capabilities of existing scanning devices as well as ensure a balance of high scanning accuracy and speed. In some embodiments, a method comprises determining nontriviality of a scene or clusters of objects via computer vision processing based on RGB data from a first sensor, such as an RGB depth (RGBD camera). Confidence scores may be determined for the computer vision processing results and used as the quantification metrics of the nontriviality, where a higher uncertainty (or lower computer vision result confidences) may indicate an appropriate condition or criterion for more information to perform object segmentation and detection. Additional geometric data may be obtained for areas with higher uncertainty levels (e.g., low confidence scores) via computer vision quantification. Based on one or more non-triviality metrics, a second sensor, such as LiDAR sensor, may be used to collect denser point cloud data in given directions that are associated with the highest uncertainties or lowest computer vision result confidences. As such, instead of uniformly increasing the resolution of LiDAR for scanning an entirety of a scene, critical areas may receive additional and more detailed scanning. Unlike conventional scanning that applies uniform density of point cloud, a desired density in a given direction or location may be determined based on uncertainty/confidence scores, where higher uncertainty (lower confidence) from computer vision classification may be associated with increased target density in LiDAR scanning.

Compared with image-based reconstruction methods, the disclosed LiDAR-based scanning is more robust to environmental changes and may be applied to real-time trends. The disclosed systems and methods may avoid the sparseness problem of a single LiDAR scan by enriching reconstruction results from multiple viewpoints to provide additional information that is sufficient for more accurately recovering 3D spatial shapes from stacked object areas.

Given pre-knowledge of RGBD detection results, a downstream LiDAR scanning process may focus on ROIs rather than a surrounding environment. More points may be collected from the ROIs to recover object surfaces and less redundant information may be included in enhancement scans which may reduce storage and computation cost. Based on dense scanning results of one or more ROIs, a density voting method that is optionally combined with (density-based spatial clustering of application with noise) DBSCAN may significantly suppress noise caused by drifting points in a scan enhancing process and highlight boundaries between objects.

Given a single LiDAR scan, the disclosed systems and methods may use information entropy to quantify the amount of lacking information to recover a targeting object. Based on an adaptive scanning strategy, a minimum number of scans may be approximated for stacked object reconstruction.

Accordingly, embodiments of the present disclosure may (i) reduce scanning time and computing cost (or increase quality with the same amount of scanning time or computing cost), and (ii) help control redundant information that may cause noisy raw data for inaccurate object detection.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

Example System Architecture

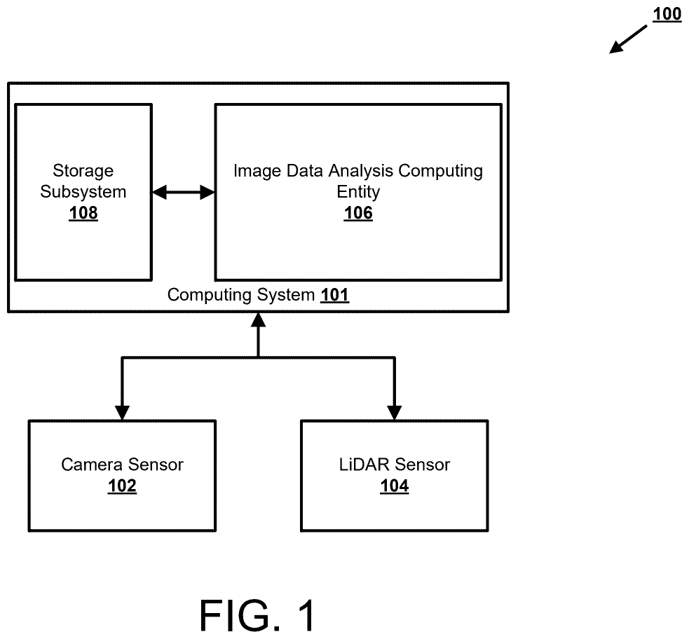

FIG. 1 is a diagram of an example architecture 100 in accordance with some embodiments of the present disclosure. The architecture 100 includes a computing system 101 configured to receive image data from a camera sensor 102, generate one or more candidate objects based on the image data, determine one or more uncertainty scores for the one or more candidate objects, determine one or more ROIs based on the one or more uncertainty scores, generate LiDAR coordinates that are associated with the ROIs, provide the LiDAR coordinates to a LiDAR sensor 104, receive point cloud data from the LiDAR sensor 104 that are associated with the LiDAR coordinates, and generate classifications based on the point cloud data.

In some embodiments, computing system 101 may communicate with at least one of the camera sensor 102 or the LiDAR sensor 104 using one or more communication networks. The one or more communication networks may comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like). The computing system 101 may further communicate with a wired data transmission protocol (e.g., Ethernet, serial port communication, universal serial bus (USB) or any other wired transmission protocol) or a wireless data transmission protocol (e.g., IEEE 802.11 (Wi-Fi), Wi-Fi Direct, 802.16 (WiMAX), ultra-wideband (UWB), infrared (IR) protocols, near field communication (NFC) protocols, Wibree, Zigbee, Bluetooth protocols, wireless USB protocols, and/or any other wireless protocol).

The computing system 101 may include an image data analysis computing entity 106 and a storage subsystem 108. The image data analysis computing entity 106 may be configured to receive image data from a camera sensor 102, generate one or more candidate objects based on the image data, determine one or more uncertainty scores for the one or more candidate objects, determine one or more ROIs based on the one or more uncertainty scores, generate LiDAR coordinates that are associated with the ROIs, provide the LiDAR coordinates to a LiDAR sensor 104, receive point cloud data from the LiDAR sensor 104 that are associated with the LiDAR coordinates, and generate classifications based on the point cloud data.

The storage subsystem 108 may be configured to store input data used by the image data analysis computing entity 106 to perform image classification. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Image Data Analysis Computing Entity

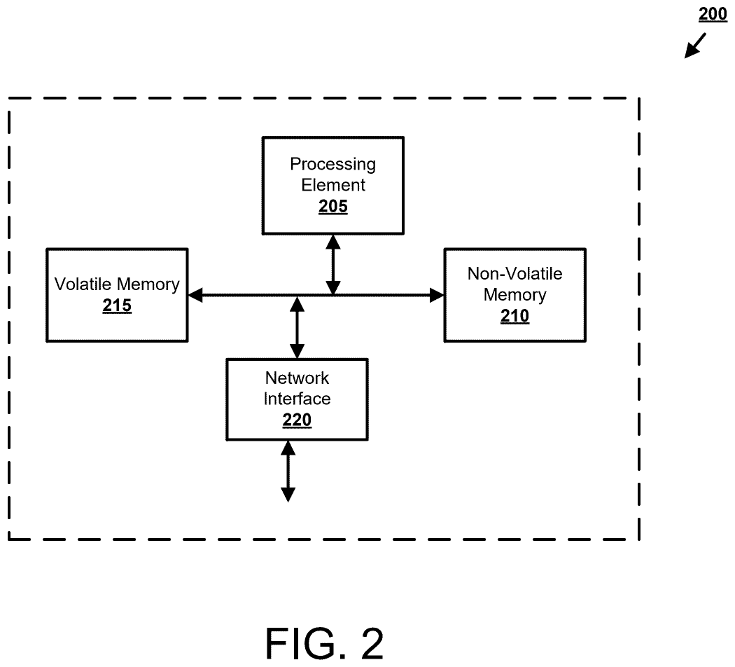

FIG. 2 provides an example computing entity 200 in accordance with some embodiments of the present disclosure. The computing entity 200 is an example of the image data analysis computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. The computing entity 200 may communicate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the computing entity 200 may operate in accordance with multiple wired communication standards and protocols, such as those described above with regard to the computing system 101.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Adaptive Scanning System

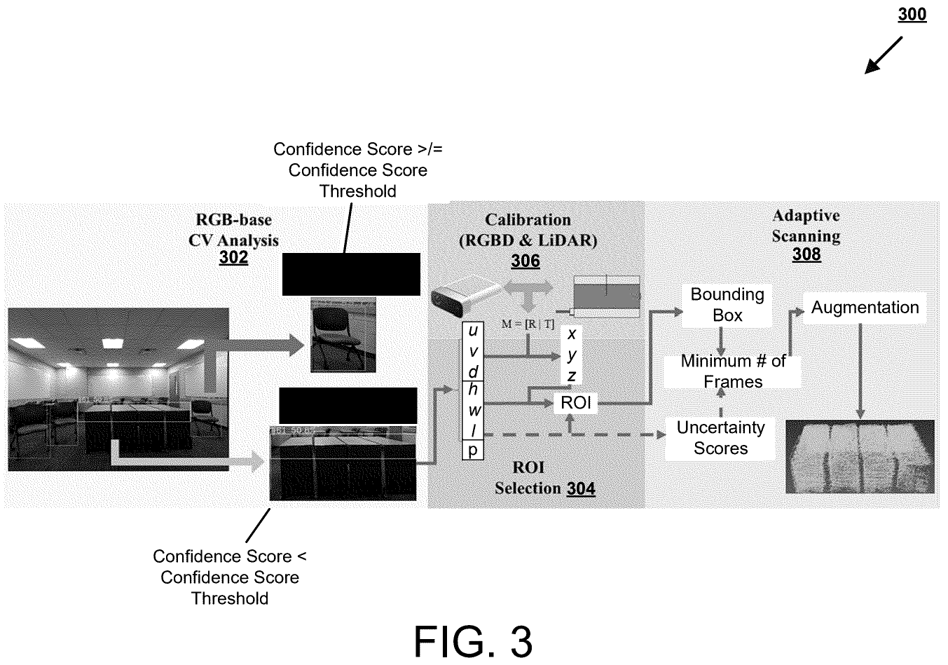

FIG. 3 is a diagram of an example adaptive scanning system 300 in accordance with some embodiments of the present disclosure. The adaptive scanning system 300 comprises an RGB-based computer vision analysis subsystem 302. The RGB-based computer vision analysis subsystem 302 may comprise a RGB camera sensor that is configured to capture, for example, a color image of a whole scene. The RGB-based computer vision analysis subsystem 302 may further comprise a pretrained image detection network (e.g., a machine learning model comprising a neural network architecture, such as a convolutional neural network) that is provided with a color image from the RGB camera sensor to generate computer vision analysis output by determining one or more potential stacked object areas (e.g., ROIs) and associated confidence scores for each potential stacked object areas.

The adaptive scanning system 300 further comprises a ROI selection subsystem 304 that is based on Shannon information entropy. The ROI selection subsystem 304 may be configured to (i) receive, for an entirety of the color image and from the RGB-based computer vision analysis subsystem 302, a plurality of confidence scores corresponding to a plurality of segments of the color image corresponding to potential stacked object areas based on the computer vision analysis generated by the RGB-based computer vision analysis subsystem 302 and (ii) determine one or more ROIs that are associated with one or more segments of the plurality of segments of the color image that may be improved (e.g., by increasing one or more confidence scores corresponding to the one or more segments) from additional scanning data.

Segments of the color image (e.g., associated with low confidence scores) that may benefit from additional scanning data may be identified as ROIs. In some embodiments, the one or more ROIs are determined based the one or more segments comprising corresponding one or more confidence scores that do not satisfy (e.g., meet or exceed) a confidence score threshold. ROIs generated by the ROI selection subsystem 304 may be adapted to a LiDAR coordinate system via an RGB-LiDAR calibration subsystem 306. The RGB-LiDAR calibration subsystem 306 may be configured to generate a transformation matrix that comprises a relative rotation and translation between the RGB camera sensor of the RGB-based computer vision analysis subsystem 302 and a LiDAR sensor of an adaptive scanning subsystem 308.

The adaptive scanning subsystem 308 is configured to determine uncertainty scores for the one or more ROIs using a Shannon information entropy that is modified based on one or more convolutional neural network (CNN) predictions. A projection function may be generated based on Shannon's information theory, where the projection function may determine a minimum number of supplementary scanning frames based on a discrepancy between the certainty of a CNN prediction (e.g., the confidence scores) and a desired level of confidence (e.g., based on the confidence score threshold). Such an approach may provide scanning enhancement while simultaneously reducing computational and storage overhead.

The adaptive scanning subsystem 308 is configured to generate an augmented map for the ROIs based on the minimum number of supplementary scanning frames. The adaptive scanning subsystem 308 may comprise a high scanning speed LiDAR sensor that enables real-time enhancement capabilities. Furthermore, the LiDAR sensor may generate point cloud data that provides a representation of the scene's subtle spatial features, which may be more comprehensive and easily registered by simultaneous localization and mapping (SLAM) algorithms compared to RGB imagery. Accordingly, abundant texture information may be provided by the RGB camera sensor for preliminary object detection and uncertainty estimation, and high-speed and stable scanning characteristics of the LiDAR sensor may be employed for further refinement.

### Example Components of an Adaptive Scanning System

### A. Scanning Methods

Vision-based scanning may comprise the usage of RGBD cameras, photogrammetry, and/or LiDAR sensors. Depth cameras may use infrared technology to capture depth information of a scene. Depth cameras may also be affordable, portable, and may provide real-time feedback. In combination with RGB sensors, depth cameras may also capture color and texture information, in addition to depth information. Photogrammetry may use structure-from-motion (SfM) data from 2D imagery to reconstruct a 3D scene. Photogrammetry may be comparably low-cost and easy to use. LiDAR sensors may use lasers to estimate ranging distance and may provide a most accurate result of a target area. LiDAR sensors are invariant to lighting changes or disturbances, making them a reliable method for reality capture. LiDAR may be applied in many architecture, engineering, or construction applications, such as as-built modeling, facility management, and structural assessment.

The aforementioned scanning methods may each have their own unique challenges. For example, RGBD cameras may be computationally and memory expensive, particularly for processing dense pixels and texture features. Photogrammetry may also demand substantial computing resources and processing time that are not suitable for a real-time solution. RGBD cameras and photogrammetry may also be affected by lighting conditions and/or environments, such as shadows and reflections. As for LiDAR sensors, the density of scanned data may become intense rapidly in a short period of time, making it difficult to transfer or process data at a fast enough refresh rate. On the other hand, cost-effective LiDAR sensors with a single scan may not provide sufficient resolution for downstream analyses, such as point cloud object recognition.

In single sensor implementations, efforts may be focused on increasing resolution and scanning perspectives to improve scanning quality. For example, 2D and 3D information may be combined to achieve better detection results. A 2D camera may be used to segment a stacked object area and then a 3D structure light camera may be used to acquire detailed scanning results for the targeting area with higher resolution. However, simply increasing scanning resolution or perspectives also increases computing cost and time, leading to inefficiency. In addition, when an amount of data generated from increased scanning resolution or perspectives is beyond a sufficient level, excessive data may lead to false positives in object boundary identification or detection rather than improving the quality of results. False positives may be particularly prevalent when detection algorithms misinterpret redundancies of raw data as actual objects. Various embodiments of the present disclosure provide sensor fusion systems and methods that are able to leverage various kinds of scanning techniques and provide a more effective and efficient solution.

### B. Multi-Sensor Reality Capture

To address the challenges of the aforementioned scanning methods, multiple-sensor fusion methods that combine LiDAR, RGBD cameras, and/or photogrammetry may be employed to leverage the advantages of each scanning method in a single scanning task. For example, multi- sensor scanning integration methods may combine or add up data from each sensor to cover different aspects of scene information, such as using RGB data to capture texture and color information, while relying on LiDAR data to model the geometrical information. In other words, separate sensors may be used in an isolated manner parallelly in order to stitch information from different sensors for a complete scan, instead of leveraging multiple sources of information to enhance the features of each sensor.

A technical challenge may exist for allowing data from one type of scanner to augment the data captured by another scanner. Without such an integrative data flow, the effectiveness of a multiple-sensor method may still be inhibited by a maximum capability of each individual scanning method. For example, stitching RGB data with LiDAR data may not address the challenge of an RGB scanning unit being affected by lighting conditions under harsh weather conditions, and thus offers low-quality texture information. According to various embodiments of the present disclosure, an adaptive approach is provided where information from one scanning technique is used to guide and augment another scanning workflow. For example, an output of a first scanning flow may be provided as an input of a second scanning process for a more concentrated and meaningful data capture that focuses on regions with the highest level of uncertainties and vagueness. Such uncertainties may be quantified by employing Shannon information theory for calculating uncertainty in raw scanning data.

### C. Shannon Information Theory

Uncertainty that is present in random variables of a system or a random process may be represented and quantified based on Shannon information theory. According to various embodiments of the present disclosure, Shannon's formulation may be used to improve efficiency of adaptive data capture, data augmentation, and analytics by quantifying an amount of information in data and identifying most informative features for capturing. For example, Shannon formulation may be modified into an information bottleneck theory for identifying the most informative features in data for classification tasks. By identifying the most informative features, the efficiency of data capture may be improved. Shannon information theory may also be used to optimize a compressive sampling process based on the most informative signal features for a large amount of raw data. Shannon information theory may also be used in data augmentation to improve the accuracy of deep learning models by measuring the diversity of augmented data to help with the generation of diverse data samples. Similarly, an adversarial and generative approach may be provided based on Shannon's maximum entropy metrics to augment data robust to noises.

Shannon's information theory may also be leveraged to improve the efficiency of deep learning. Deep learning models may comprise functions that provide feature extraction and enhancement. Input data samples may be provided to a deep learning model (e.g., via a training process) for supporting the generation of predictions with different confidence or probabilities. Accordingly, Shannon's information theory may be applied to analyze and evaluate information extraction efficiency of different models.

Network performance may also be improved by applying Shannon's information theory. In some embodiments, a prior-based conditional information entropy and a corresponding regularizer are provided for optimizing the convergent process. A regularization method may be used compress the entropy of prediction-related variables. Uninformative frames may be filtered from an image sequence by applying a modified entropy calculation method based on Shannon entropy as a new loss function to train a model to detect less informatic frames and stabilize the model's performance.

Thus, on a basis that Shannon information theory may be used as a feature extraction tool for concentrating analytical processes on the most value-added parameters or portions of input data, an information demand quantification formulation for guiding an amount of added LiDAR scanning data may be provided based on a revised formulation of Shannon information theory.

### Example System Operations

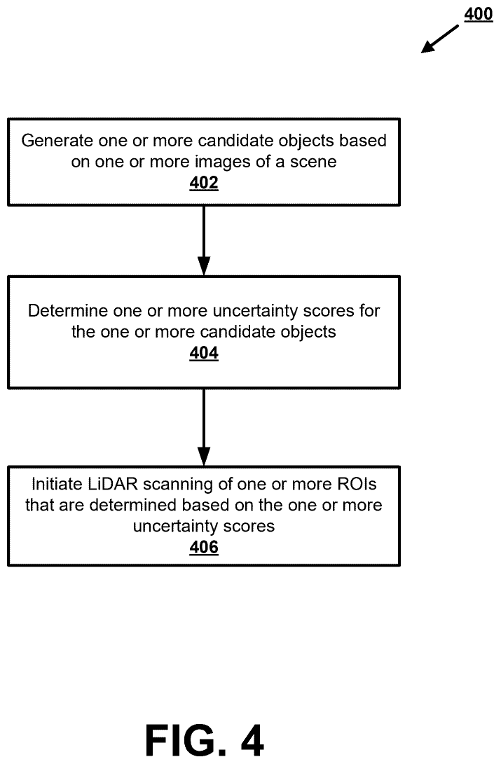

FIG. 4 presents a flowchart of an example process 400 for enhancing image scans in accordance with some embodiments of the present disclosure. The flowchart diagram depicts a method for LiDAR scanning based on Shannon information theory to account for geometrical nontriviality. The process 400 may be implemented by one or more computing devices, entities, and/or systems described herein. For example, via the various steps/operations of the process 400, the computing system 101 may perform computer vision analysis on a scene image as a preliminary object detection task to determine a confidence score of an ROI, determine information uncertainties in the ROI by using a formulation of Shannon's entropy based on the confidence score, wherein the formulation provides the information uncertainties as a quantitative measure and/or appropriate amount of additional data from secondary scanning via a LiDAR sensor to reduce the information uncertainties.

In some embodiments, the process 400 begins at step/operation 402 when the computing system 101 generates one or more candidate objects based on one or more images of a scene. A scene may comprise clustered and stacked objects, occlusions, and insignificant silhouette features from given scanning perspectives. The one or more images may comprise RGBD (or color depth) images that are captured by a RGBD camera sensor. Generating the one or more candidate objects may comprise using RGB computer vision-based object detection to estimate (e.g., via confidence scores) the uncertainty of nontrivial geometric features (e.g., the one or more candidate objects) in the scene. In the context of adaptive scanning, the selection of an appropriate image-based object detection model is important since it directly affects not only the reliability and accuracy of object detections but also the overall efficiency of the scanning process, especially in real-time applications. In some embodiments, unlike other computer vision applications that focus on detecting objects as a final goal, the one or more candidate objects may be provided as input for Shannon information entropy calculation.

Based on the one or more images captured by the RGBD camera sensor, a pre-trained single-shot multi-box detection (SSD) model may be used as a classifier for object detection. SSD, which is notable for its speed, efficiency, and accuracy, may quickly locate and classify objects in one step without multiple processing stages. As such, SSD offers a balanced blend of speed, accuracy, and computational efficiency, which may be beneficial in adaptive scanning, ensuring timely and accurate feedback. The streamlined design of the SSD model enables swift object localization and classification in a single pass, making the SSD model agile for real-time operations. The SSD may also generate consistent confidence score outputs. This uniformity allows for reliable determination of a minimum amount of information for scanning, enhancing adaptability and efficiency of the disclosed scanning process.

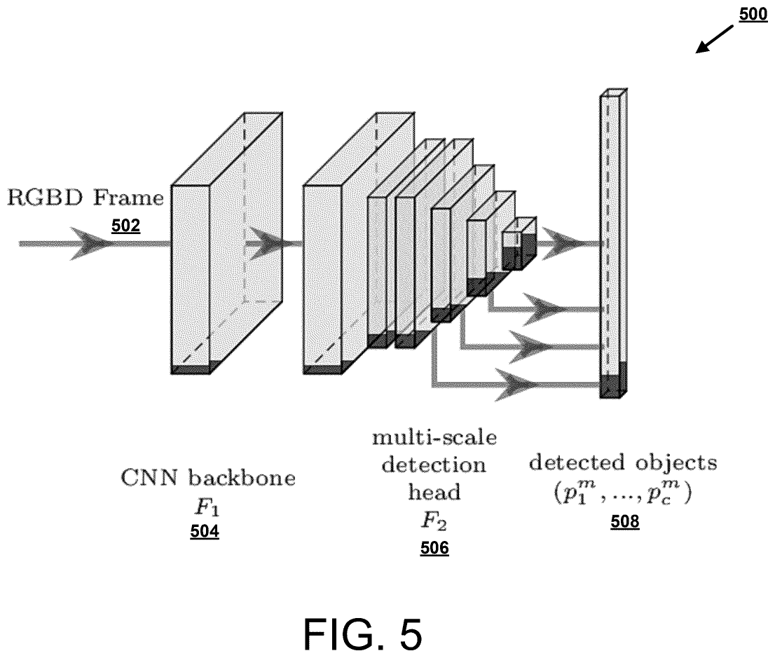

FIG. 5 is an example SSD model 500 in accordance with some embodiments of the present disclosure. An SSD model 500 may comprise a CNN architecture as a function pair (F₁, F₂) to provide an initial guess of object-wise classification. In some embodiments, the one or more candidate objects may be collected as n×(c+4), where n may represent a number of objects detected from an image, c may represent a number of confidence scores for all potential types (e.g., classes), and the ‘4’ may represent parameters that are associated with the coordinates and size of a bounding box. For the purposes of simplification, single pixels from an RGB image may be represented as px and the k-th pixels on an object i may be represented as

$$p {x}_{i}^{k} .$$

A raw image (RGBD frame 502) may be provided to a pretrained CNN backbone F₁ 504 for feature extraction. A multi-scale detection head F₂ 506 may then be applied to predict final objects (detected objects

$${p}_{1}^{m} , … , {p}_{c}^{m}$$

508). CNN backbone F₁ 504 and multi-scale detection head F₂ 506 may extract relevant information Y, represented as Y={yᵢ|yᵢ∈ [symbol] ^{c+4}, i={1,2, . . . , n̅}}, that an input pixel set PX contains about ground-truth locations and sizes for one or more objects, where n may represent ground-truth number of objects. In some embodiments, Y comprises a list of bounding boxes that crop one or more candidate objects on an image plane.

Referring back to FIG. 4, in some embodiments, at step/operation 404, the computing system 101 determines one or more uncertainty scores for the one or more candidate objects. In some embodiments, determining the one or more uncertainty scores comprises providing the ground-truth locations and sizes for the one or more objects, Y as an input for a formulation of Shannon information entropy and selecting one or more ROIs (e.g., bounding boxes) with higher uncertainties for downstream adaptive scanning. In some embodiments, bounding boxes with the highest uncertainties are identified as target ROIs for further attention.

According to some embodiments, determining ROIs comprises quantitatively measuring certainty (e.g., uncertainty scores) that is associated with the one or more candidate objects. In some embodiments, an information entropy (H) may be applied from Shannon information theory for quantifying uncertainty that is associated with one or more candidate objects and an amount of information that is sufficient to encode the one or more candidate objects. In some embodiments, given an input (e.g., the one or more images of the scene) and output (e.g., the one or more candidate objects) of a CNN network, the information entropy of a selected ROI may be represented as H(y̅), where y̅ may comprise a predicted confidence score vector of an object in a ROI. A higher H(y̅) may be associated with more information involved for a deterministic and reliable prediction. H(y̅) may be defined as

$$H ( \overline{y} ) := - {\sum }_{i = 1}^{c} {\overline{y}}_{i} \cdot ln ( {\overline{y}}_{i} ) \qquad Equation 1$$

The CNN network may output the confidence score vector y̅=[p₁, p₂, . . . , pₙ]^{T} for each object, where each p; may represent a probability of a current object belonging to type i and the largest pᵢ may be kept as a final score: p^{max}=max(y̅). According to Shannon's information theory, the information entropy (H) of object m on all types may be determined by:

$$H ( {\overline{y}}_{m} ) = - {\sum }_{i = 1}^{c} {p}_{i}^{m} ● ln ( {p}_{i}^{m} ) \qquad Equation 2$$

If k ROIs are detected from a given image, their information entropies may be represented by:

$${H}_{list} := [ {H}_{1} ( \overline{y} ) , {H}_{2} ( \overline{y} ) , … , {H}_{k} ( \overline{y} ) ] \qquad Equation 3$$

Therefore, once Hₗᵢₛₜ is obtained, a ROI with high H(y̅ₘ) may be selected as a potential stacked object area and a corresponding predicted parameters {Regₘ=[uᵢ, vᵢ, dᵢ, hᵢ, wᵢ]^{T}|i ∈[1,l]} may be saved. The size and location of the ROI may be determined in LiDAR coordinates for adaptive scanning based on the predicted parameters. To ensure the reliability of the detection results, a threshold of uncertainty Hₜₕᵣₑₛₕ may be configured to determine that a detected ROI with an uncertainty score lower than Hₜₕᵣₑₛₕ may be treated as a reliable result.

In some embodiments, at step/operation 406, the computing system 101 initiates LiDAR scanning of one or more ROIs that are determined based on the one or more uncertainty scores. Initiating the LiDAR scanning may comprise guiding scanning using a 3D LiDAR sensor with varying resolutions for each ROI based on quantified uncertainties H(y̅). In some embodiments, the RGBD camera sensor and the 3D LiDAR sensor are calibrated and the locations of the one or more ROIs are transformed into a 3D LiDAR coordinate system (e.g., with x, y, z coordinates), Reg_{LiDAR}. In some embodiments, the number of additional LiDAR frames n_{LiDAR} for enhancement is determined by a linear estimator using the desired Hₜₕᵣₑₛₕ and an initial H(y̅) from a RGB detector (e.g., the SSD model). In some embodiments, a pre-estimated n_{LiDAR} may avoid extra scanning time and storage costs. A LiDAR sensor may then be used to continuously collect point cloud frames within the Reg_{LiDAR} to add enhancement information to reduce the detection uncertainty H(y̅).

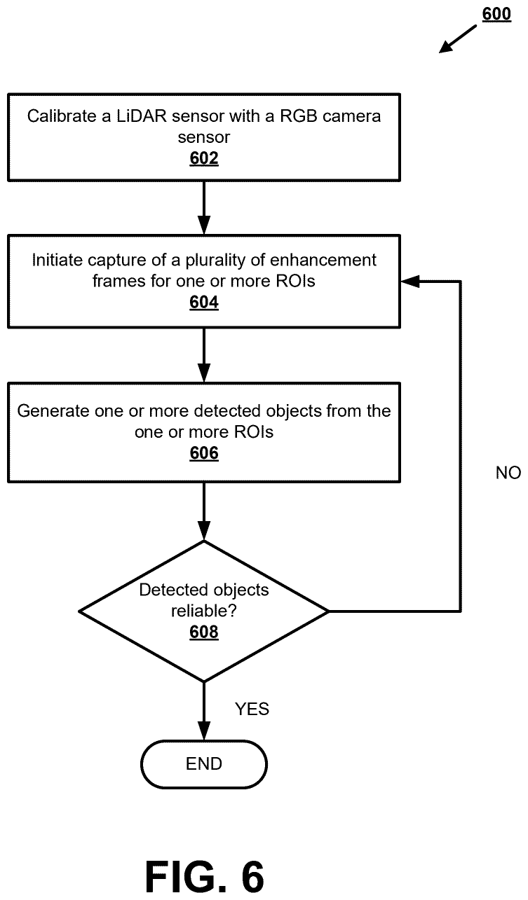

In some embodiments, step/operation 406 may be performed in accordance with the process that is depicted in FIG. 6. The process 600 that is depicted in FIG. 6 starts at step/operation 602 when the image data analysis computing entity 106 calibrates a LiDAR sensor with a RGB camera sensor. In some embodiments, calibrating the LiDAR sensor comprises generating a transformation matrix from RGB to LiDAR. The transformation matrix may establish correspondences between 3-D lidar points and 2-D camera data to fuse the LiDAR and RGB camera sensor outputs together. For example, while the RGB camera sensor may capture color, texture, and appearance information, the LiDAR sensor may capture 3D structural information of an environment. Additionally, the RGB camera sensor and the lidar sensor each captures data with respect to their own coordinate system. As such, calibrating the LiDAR sensor with the RGB camera sensor may comprise converting data from the RGB camera sensor and the LiDAR sensor into a same coordinate system. In some embodiments, calibrating the LiDAR sensor with the RGB camera sensor comprises estimating external parameters of the RGB camera sensor and the LiDAR sensor, such as location and/or orientation, to establish relative geometric relationships (e.g., rotation and translation) between the sensors (e.g., their coordinate systems). Calibrating the LiDAR sensor with the RGB camera sensor may comprise using calibration objects, such as planar boards with checkerboard patterns. For example, performing a calibration of the LiDAR sensor with the RGB camera sensor may comprise using the RGB camera sensor and the LiDAR sensor to capture and extract features of the calibration objects to generate a transformation matrix that establishes relative geometric relationships between the coordinate systems of the RGB camera sensor and the LiDAR sensor. A resulting transformation matrix may be used to evaluate the accuracy of the calibration by determining a calibration loss. Determining whether the estimated transformation matrix is accurate enough to perform an object-wise coordinate conversion between the LiDAR sensor and the RGB camera sensor may be based on the calibration loss.

In some embodiments, at step/operation 604, the computing system 101 initiates capture of a plurality of enhancement frames for one or more ROIs. The plurality of enhancement frames may comprise additional scanning frames of ROIs from multiple viewpoints using a LiDAR sensor. In some embodiments, the plurality of enhancement frames is captured by moving the LiDAR sensor about an initial scan S₁ to capture frames focusing on the ROIs from different viewing points and projecting consequential frames S₁, S₂, . . . , Sₙ back into the coordinate system of S₁ using SLAM. Sₜ may refer to a local coordinate system with a world location of the LiDAR sensor at timestamp t of the origin. Thus, a final scanning result may include more detailed information about ROIs.

Information to be used for prediction may comprise the surface point cloud from a certain viewpoint with 3D coordinates. For example, a PointNet++ model may be applied to make a prediction of a captured point cloud and an output may comprise a confidence score vector denoted by y̅_{LiDAR}_{ᵢ} where i may refer to the i-th object detected in the ROI.

For each frame from a different viewing angle, the LiDAR sensor may capture new reflected points from an unseen object surface and gather additional information denoted as ΔInfo. Given a minimum amount of information to achieve Hₜₕᵣₑₛₕ, denoted as Infoₜₕᵣₑₛₕ, and an amount of information from the initial frame, denoted as Info₀, an uncertainty of prediction given Info₀ may be represented as H(y̅_{LiDAR}⁰). It may be assumed that (i) the ΔInfo_{LiDAR} for each frame is approximately the same and is linearly related to the number of points Nₚₜₛ in each LiDAR frame and (ii) the change of H(y̅_{LiDAR}) and ΔH(y̅_{LiDAR}), may be linearly related to ΔInfo. As such, the number of points Nₚₜₛ may be determined by:

$${N}_{pts} = θ●Δ H \qquad Equation 4$$

The minimum number of LiDAR frames to achieve Infoₜₕᵣₑₛₕ may be obtained by:

$${n}_{LiDAR} = \frac{{Info}_{thresh} - {Info}_{0}}{Δ Info} = \frac{{H}_{thresh} - {H}_{0}}{Δ H} = \frac{θ● ( {H}_{thresh} - {H}_{0} )}{{N}_{pts}} \qquad Equation 5$$

where θ may represent a coefficient parameter between Nₚₜₛ and ΔH. Note that θ may be a constant parameter given the same type of LiDAR sensor.

In some embodiments, at step/operation 606, the computing system 101 generates one or more detected objects from the one or more ROIs based on the plurality of enhancement frames. Generating the one or more detected objects may comprise combining the plurality of enhancement frames by using LOAM (LiDAR odometry and mapping) in real-time to implement SLAM such that the plurality of enhancement frames that are associated with different viewpoints may be merged within a relatively small space and resolution of an entire image scene may be improved. In some embodiments, generating the one or more detected objects comprises multi frames registration (FEMF) and voting-based clustering (VBC). FEMF may comprise (i) extracting a plurality of planar points and edge points as feature points from the plurality of enhancement frames and (ii) determining frame-wise correspondences by pairing the feature points of adjacent frames. Based on the paired feature pairs, one or more translation matrices may be generated and consequential frames S₁, S₂, . . . , Sₙ may be projected back into the coordinate system of S₁ using SLAM. The plurality of enhancement frames may be provided to VBC based on the FEMF to filter the noise points and redundant information.

According to various embodiments of the present disclosure, at least portions of steps/operations 604 through 606 (e.g., capturing of the plurality of enhancement frames, FEMF, or VBC) comprise a loop for stacked object detection and object splitting from one or more ROIs. The one or more detected objects may be stored in the form of a point cloud as

$${PC}_{i}^{lp}$$

where lp may represent a loop number and i may denote an index of an object detected.

Each loop may comprise capturing and processing a new scan for enhancement. After each loop a plurality of point clouds

$$\{ {PC}_{i}^{lp} \vert i ∈ [ 1 , {num}_{obj} ] \}$$

may be provided to a classifier model, such as a pre-trained PointNet++ model for object-wise classification (i.e., generating the one or more detected objects), where num_{obj} may represent a number of separated objects. The classifier model may also generate a confidence vector prediction for each point cloud as

$${\overline{y}}_{LiDAR}^{lp} = {[ {\overline{y}}_{LiDAR}^{lp} 1 , {\overline{y}}_{LiDAR}^{lp} 2 , … , {\overline{y}}_{LiDAR}^{lp} {num}_{obj} ]}^{T} .$$

In some embodiments, at step/operation 608, the computing system 101 determines whether the one or more detected objects are reliable. In some embodiments, determining the reliability of the one or more detected objects comprises determining whether one or more information entropies of the one or more ROIs that are enhanced based on the plurality of enhancement frames are approximately equal to an information entropy threshold. By setting lp=n_{LiDAR.}, the information entropy H(ROI)ⁿ^{_{LiDAR}} for the one or more ROIs is calculated by the average of

$$H ( {\overline{y}}_{LiDAR}^{{n}_{LiDAR}} )$$

as

$${H ( ROI )}^{{n}_{LiDAR}} = \frac{{\sum }_{m = 1}^{{num}_{obj}} H ( {\overline{y}}_{LiDAR}^{{n}_{LiDAR}} m )}{{num}_{obj}} = \frac{{\sum }_{p = 1}^{{num}_{obj}} {\sum }_{q = 1}^{c} - {\overline{y}}_{LiDAR}^{{n}_{LiDAR}} {m}_{q} ●ln ( {\overline{y}}_{LiDAR}^{{n}_{LiDAR}} {m}_{q} )}{{num}_{obj}} \qquad Equation 6$$

where H(ROI)ⁿ^{_{LiDAR}} is approximately equal to Hₜₕᵣₑₛₕ.

To further verify a reliability of the one or more detected objects based on a determination, using Equation 5, of the minimum amount of information (e.g., enhancement frames) to achieve Hₜₕᵣₑₛₕ, the average confidence score of all the one or more detected objects may be aggregated as:

$${p}_{ROI}^{lp} = \frac{{\sum }_{i = 1}^{{num}_{obj}} {p}_{gt}}{{num}_{obj}} \qquad Equation 7$$

where p_{gt} may represent the predicted confidence score for the correct type. The convergence point of

$${p}_{ROI}^{lp}$$

may be verified with the corresponding loop number lp as the actual minimum number of augmentation frames. A series of values

$${p}_{ROI}^{1} , {p}_{ROI}^{2} , … , {p}_{ROI}^{lp}$$

may be obtained along with the difference

$$Δ {p}_{ROI}^{1} = {p}_{ROI}^{2} - {p}_{ROI}^{1} , Δ {p}_{ROI}^{2} = {p}_{ROI}^{3} - {p}_{ROI}^{2} , … , Δ {p}_{ROI}^{3} = {p}_{ROI}^{4} - {p}_{ROI}^{3} .$$

The evaluation process may stop when Δp_{ROI}ⁱ→0 and the number of frames may be recorded as a converging number n_{con}. For example, once n_{con} of enhancement frames are collected, uncertainty scores for the one or more ROIs may be stable even if new enhancement frames are collected. Accordingly, reliability of the one or more detected objects (and determination of the effectiveness of n_{LiDAR}) may be based on (i) H(ROI)ⁿ^{_{LiDAR}}≥Hₜₕᵣₑₛₕ to ensure that uncertainty scores of the one or more ROIs are below a threshold or (ii) n_{LiDAR}≤n_{con} to ensure that there is no extra computational and storage cost.

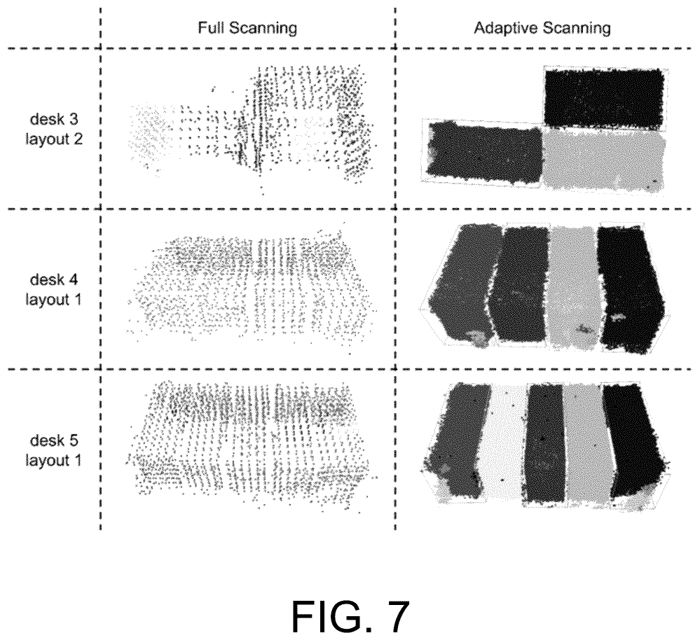

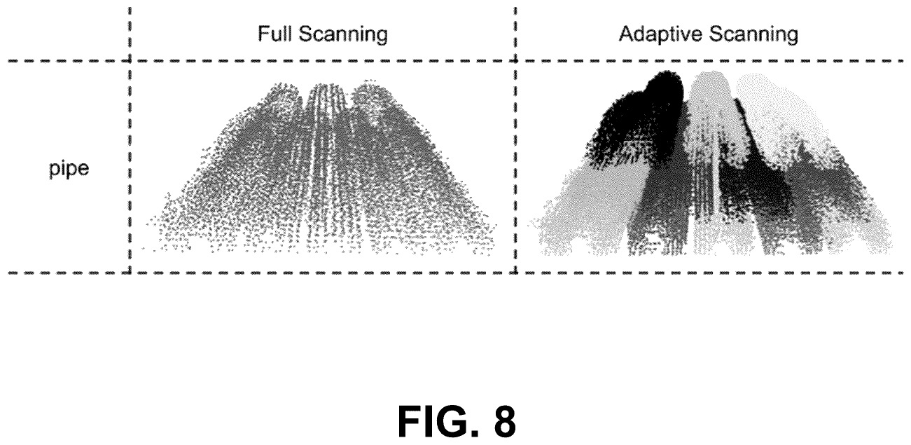

FIG. 7 and FIG. 8 are renderings of example clustering results by full-scene enhancement scanning and adaptive scanning results for desk groups and a pipe group, respectively, in accordance with some embodiments of the present disclosure.

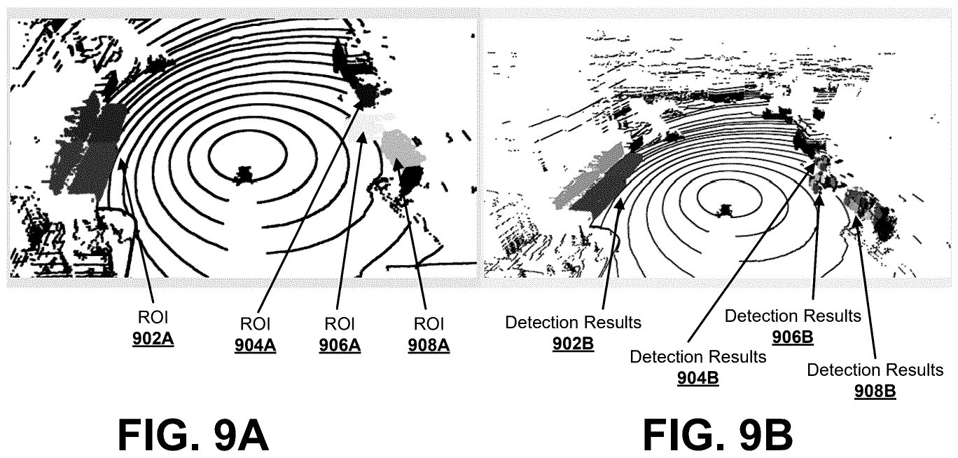

FIG. 9A and FIG. 9B are first view renderings of example augmented results of adaptive scanning on ROIs in accordance with some embodiments of the present disclosure. FIG. 9A depicts color points indicating augmented point clouds for ROI 902A, ROI 904A, ROI 906A, and ROI 908A. FIG. 9B depicts detection results 902B, detection results 904B, detection results 906B, and detection results 908B that are representative of individual objects detected via adaptive scanning in ROI 902A, ROI 904A, ROI 906A, and ROI 908A, respectively, in FIG. 9A.

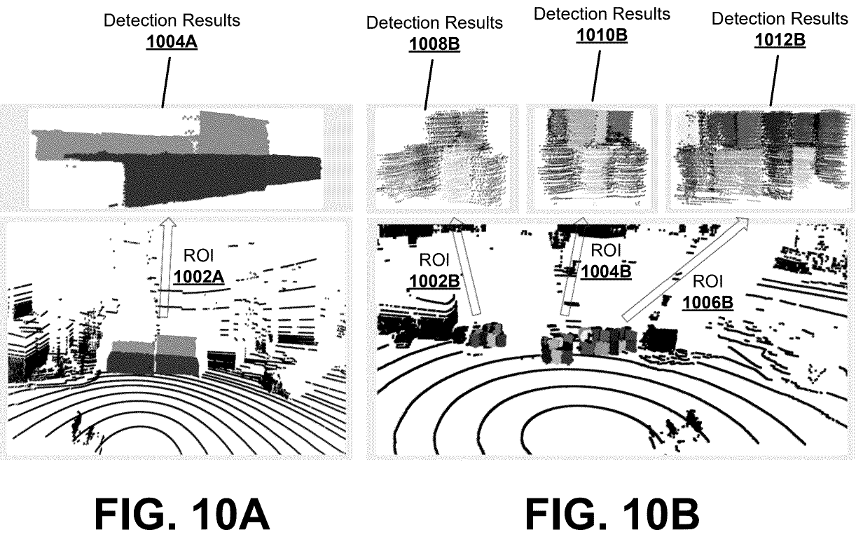

FIG. 10A and FIG. 10B are second view renderings of example detailed detection results of ROIs in accordance with some embodiments of the present disclosure. ROI 1002A is depicted in FIG. 10A comprising detection results 1004A generated based on adaptive scanning. ROI 1002A and detection results 1004A correspond to ROI 902A and detection results 902B, respectively, in FIGS. 9A and 9B. ROI 1002B, ROI 1004B, and ROI 1006B are depicted in FIG. 10B comprising detection results 1008B, detection results 1010B, and detection results 1012B. ROI 1002B, ROI 1004B, and ROI 1006B correspond to ROI 904A, ROI 906A, and ROI 908A, respectively in FIG. 9A. Detection results 1008B, detection results 1010B, and detection results 1012B correspond to detection results 904B, detection results 906B, and detection results 908B, respectively, in FIG. 9B.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method comprising:
generating, by one or more processors and using a convolutional neural network model, one or more candidate objects based on one or more images of a scene, wherein the one or more images comprise one or more color depth images that are captured by a camera sensor;
determining, by the one or more processors, one or more uncertainty scores for the one or more candidate objects based on an information entropy function; and
initiating, by the one or more processors and using a sparse light detection and ranging (LiDAR) sensor, scanning of one or more regions of interest (ROIs) that are determined based on the one or more uncertainty scores, wherein the scanning comprises:
(i) initiating capture of one or more enhancement frames for the one or more ROIs and
(ii) generating one or more detected objects from the one or more ROIs based on the one or more enhancement frames.

2. The computer-implemented method of claim 1, wherein initiating the scanning further comprises scanning the one or more ROIs with one or more resolutions based on the one or more uncertainty scores.

3. The computer-implemented method of claim 1 further comprising calibrating the LiDAR sensor by generating a transformation matrix that transforms data from the one or more color depth images corresponding to the one or more ROIs into one or more LiDAR points in a three-dimensional coordinate system.

4. The computer-implemented method of claim 1, wherein the one or more enhancement frames comprises one or more scanning frames corresponding to the one or more ROIs from a plurality of viewpoints.

5. The computer-implemented method of claim 4, wherein generating the one or more detected objects further comprises combining the one or more enhancement frames by merging the one or more scanning frames from the plurality of viewpoints.

6. The computer-implemented method of claim 1, wherein generating the one or more detected objects further comprises generating, using a classifier model, one or more predictions based on surface point cloud data, wherein the one or more predictions comprises a confidence score vector that corresponds to the one or more detected objects.

7. The computer-implemented method of claim 1 further comprising determining a reliability of the one or more detected objects based on one or more information entropies of the one or more ROIs satisfying an information entropy threshold.

8. The computer-implemented method of claim 1, wherein generating the one or more candidate objects further comprises determining, using red, green, blue (RGB) computer vision-based object detection, one or more confidence scores for the one or more candidate objects.

9. A system comprising:
one or more processors and
at least one memory storing processor-executable instructions that, when executed by any of the one or more processors, causes the one or more processors to perform operations comprising:
generating, using a convolutional neural network model, one or more candidate objects based on one or more images of a scene, wherein the one or more images comprise one or more color depth images that are captured by a camera sensor;
determining one or more uncertainty scores for the one or more candidate objects based on an information entropy function; and
initiating, using a sparse light detection and ranging (LiDAR) sensor, scanning of one or more regions of interest (ROIs) that are determined based on the one or more uncertainty scores, wherein the scanning comprises:
(i) initiating capture of one or more enhancement frames for the one or more ROIs and
(ii) generating one or more detected objects from the one or more ROIs based on the one or more enhancement frames.

10. The system of claim 9, wherein initiating the scanning further comprises scanning the one or more ROIs with one or more resolutions based on the one or more uncertainty scores.

11. The system of claim 9, wherein the operations further comprise calibrating the LiDAR sensor by generating a transformation matrix that transforms data from the one or more color depth images corresponding to the one or more ROIs into one or more LiDAR points in a three-dimensional coordinate system.

12. The system of claim 9, wherein the one or more enhancement frames comprises one or more scanning frames corresponding to the one or more ROIs from a plurality of viewpoints.

13. The system of claim 12, wherein generating the one or more detected objects further comprises combining the one or more enhancement frames by merging the one or more scanning frames from the plurality of viewpoints.

14. The system of claim 9, wherein generating the one or more detected objects further comprises generating, using a classifier model, one or more predictions based on surface point cloud data, wherein the one or more predictions comprises a confidence score vector that corresponds to the one or more detected objects.

15. The system of claim 9, wherein the operations further comprise determining a reliability of the one or more detected objects based on one or more information entropies of the one or more ROIs satisfying an information entropy threshold.

16. The system of claim 9, wherein generating the one or more candidate objects further comprises determining, using red, green, blue (RGB) computer vision-based object detection, one or more confidence scores for the one or more candidate objects.

17. One or more non-transitory computer-readable storage media including instructions that, when executed by one or more processors, cause the one or more processors to perform operations comprising:
generating, using a convolutional neural network model, one or more candidate objects based on one or more images of a scene, wherein the one or more images comprise one or more color depth images that are captured by a camera sensor;
determining one or more uncertainty scores for the one or more candidate objects based on an information entropy function; and
initiating, using a sparse light detection and ranging (LiDAR) sensor, scanning of one or more regions of interest (ROIs) that are determined based on the one or more uncertainty scores, wherein the scanning comprises:
(i) initiating capture of one or more enhancement frames for the one or more ROIs and
(ii) generating one or more detected objects from the one or more ROIs based on the one or more enhancement frames.

18. The one or more non-transitory computer-readable storage media of claim 17, wherein initiating the scanning further comprises scanning the one or more ROIs with one or more resolutions based on the one or more uncertainty scores.

19. The one or more non-transitory computer-readable storage media of claim 17, wherein the operations further comprise calibrating the LiDAR sensor by generating a transformation matrix that transforms data from the one or more color depth images corresponding to the one or more ROIs into one or more LiDAR points in a three-dimensional coordinate system.

20. The one or more non-transitory computer-readable storage media of claim 17. wherein the one or more enhancement frames comprises one or more scanning frames corresponding to the one or more ROIs from a plurality of viewpoints.
